(19) United States
(12) Patent Application Publication
(10) Pub. No.: US 2024/0226829 A1
(43) Pub. Date: Jul. 11, 2024

(54) BLENDER AND METHOD OF BLENDING

(71) Applicant: Daniel J. Raymond, Saginaw, MI (US)

(72) Inventor: Daniel J. Raymond, Saginaw, MI (US)

(21) Appl. No.: 18/406,364

(22) Filed: Jan. 8, 2024

Related U.S. Application Data
(60) Provisional application No. 63/437,482, filed on Jan. 6, 2023.

(51) Int. Cl. B01F 33/501; A47J 43/046; A47J 43/07; A47J 43/08; B01F 27/112; B01F 27/213

(52) U.S. Cl. CPC B01F 33/50114; A47J 43/046; A47J 43/0722; A47J 43/085; B01F 27/112; B01F 27/213; B01F 2101/06

(57) ABSTRACT

The blender includes a motorized handheld tool, which has a chuck. The blender also includes a container that has an open interior and at least one open end. A cap is attachable with the at least one open end of the container to enclose the interior of the container. A rotatable blade piece extends through the cap between a blade end on one side of the cap and a shank end on an opposite side of the cap. The blade end has a plurality of blades. The shank end of the rotatable blade piece is received in the chuck of the motorized handheld tool.

### CROSS-REFERENCE TO RELATED APPLICATION

This utility application claims the benefit of U.S. Provisional Application No. 63/437,482 filed Jan. 6, 2023 titled “BLENDER AND METHOD OF BLENDING”. The provisional application is incorporated by reference herein as if reproduced in full below.

### BACKGROUND

### 1. Field

The present invention is related generally to blenders.

### 2. Related Art

A blender is a kitchen appliance that is used to mix, puree, or emulsify food and other substances. It consists of a blender jar or container with a rotating metal blade at the bottom, a base with a motor, and a lid. Some blenders also have additional features such as variable speed settings or a pulse button. The base of the blender houses the motor and controls, and is usually made of plastic or metal. The blender jar or container is typically made of glass or plastic, and it holds the ingredients that are being blended. The lid of the blender sits on top of the jar and helps to keep ingredients from splashing out during blending. The blade of the blender is located at the bottom of the jar and is responsible for chopping, grinding, and blending the ingredients.

### SUMMARY

One aspect of the present disclosure is related to a blender that has a container with an open interior and at least one open end. The blender also includes a cap that is attachable with the at least one open end of the container to enclose the interior of the container. A rotatable blade piece extends through the cap between a blade end on one side of the cap and a shank end on an opposite side of the cap. The blade end has a plurality of blades, and the shank end is shaped to be received in a chuck of a handheld tool.

According to another aspect of the present disclosure, at least a portion of the shank end of the rotatable blade piece has a hexagonal shape.

According to yet another aspect of the present disclosure, the blade end of the rotatable blade piece has at least four blades with sharp edges.

According to still another aspect of the present disclosure, the cap is threadedly attachable with the at least one open end of the container.

According to a further aspect of the present disclosure, the rotatable blade piece is made of metal.

Another aspect of the present disclosure is related to a blender assembly that includes a motorized handheld tool, which has a chuck. The blender assembly also includes a container that has an open interior and at least one open end. A cap is attachable with the at least one open end of the container to enclose the interior of the container. A rotatable blade piece extends through the cap between a blade end on one side of the cap and a shank end on an opposite side of the cap. The blade end has a plurality of blades. The shank end of the rotatable blade piece is received in the chuck of the motorized handheld tool.

According to another aspect of the present disclosure, at least a portion of the shank end of the rotatable blade piece has a hexagonal shape.

According to yet another aspect of the present disclosure, the blade end of the rotatable blade piece has at least four blades with sharp edges.

According to still another aspect of the present disclosure, the cap is threadedly attachable with the at least one open end of the container.

According to a further aspect of the present disclosure, the rotatable blade piece is made of metal.

According to yet a further aspect of the present disclosure, the motorized handheld tool is an impact driver.

Yet another aspect of the present disclosure is related to a method of blending a product. The method includes the step of inserting a product to be blended into a container that has an open interior and at least one open end. The method continues with the step of fixing a cap to the at least one open end of the container to enclose the product within the open interior. A rotatable blade piece extends through the cap and has a blade end, which is disposed within the open interior of the container, and a shank end, which is disposed outside of the open interior of the container. The method proceeds with the step of inverting the container so that the container is vertically above the cap. The method continues with the step of inserting a shank end of the blade piece into a chuck of a motorized handheld tool. The method proceeds with the step of activating the motorized handheld tool to rotate the blade piece relative to the cap and blend the product in the open interior of the container.

According to another aspect of the present disclosure, at least a portion of the shank end of the rotatable blade piece has a hexagonal shape.

According to yet another aspect of the present disclosure, the method further includes the step of threadedly engaging the cap with the at least one open end of the container.

According to still another aspect of the present disclosure, the rotatable blade piece is made of metal.

According to a further aspect of the present disclosure, the motorized handheld tool is an impact driver.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective view of a blender according to an example embodiment of the present disclosure;

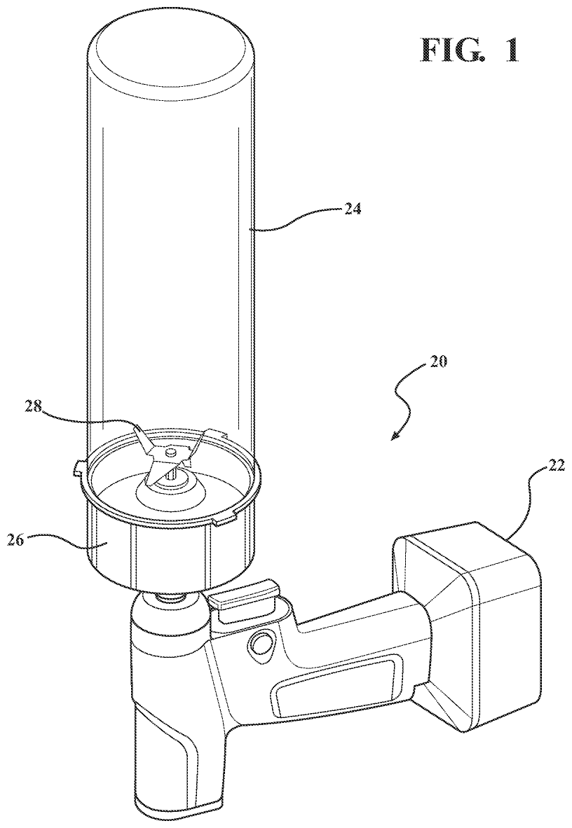

FIG. 2 is an exploded view of the blender of FIG. 1;

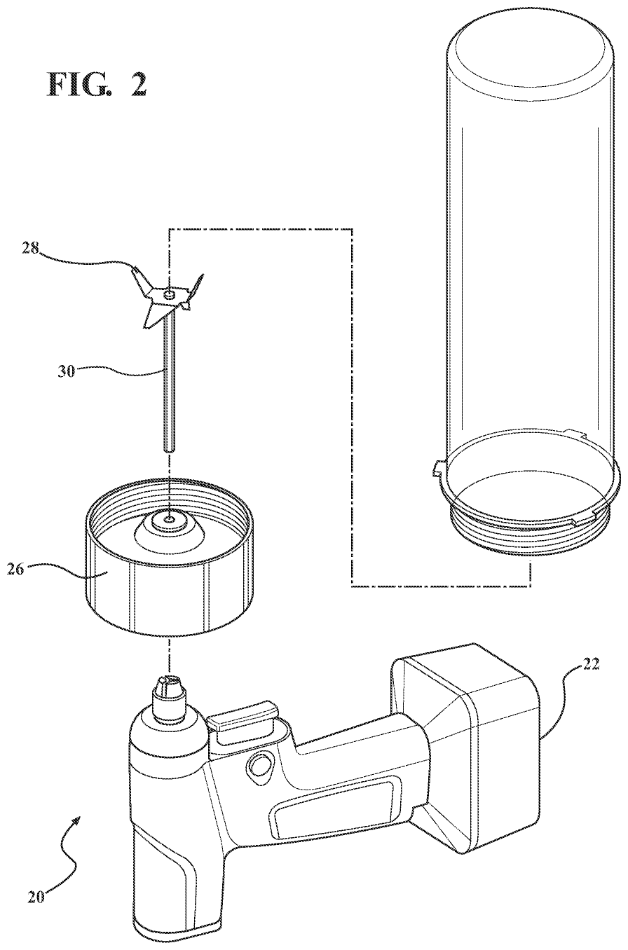

FIG. 3 is an enlarged view of a portion of a shank end of the blade piece; and

FIG. 4 is a perspective view of the blender during use.

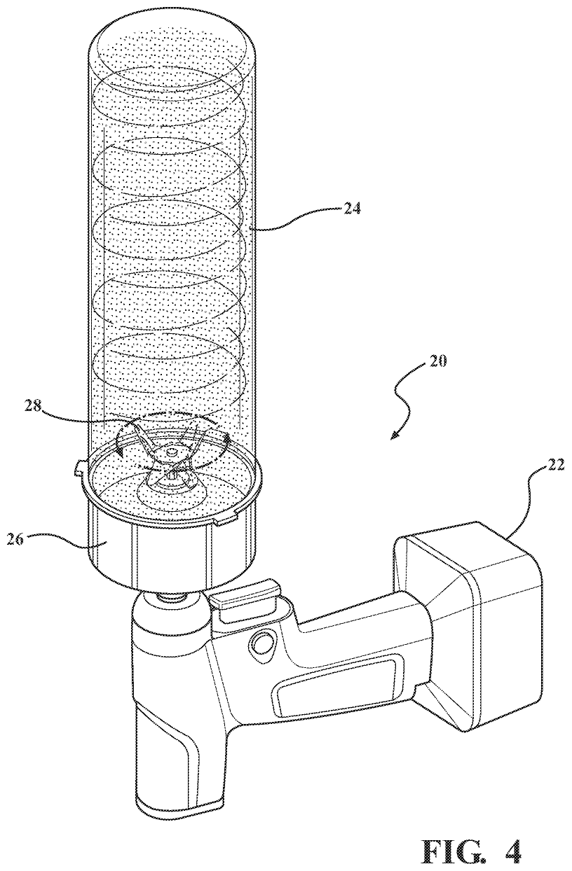

### DESCRIPTION OF THE ENABLING EMBODIMENT

Referring to the Figures, wherein like numerals indicate corresponding parts throughout the several views, one aspect of the present disclosure is related to a portable blender 20 that can be powered by a handheld drill or impact driver 22 (or any suitable handheld motorized tool with a rotational output). The blender 20 can be used to mix components on a job site (for example, drywall putty) or can be used to blend food or perform any suitable blending or mixing operation.

The blender 20 includes a blender jar or container 24 that is generally cylindrical in shape and has an open first end and a closed second end. An outer surface of the container 24 is threaded adjacent the open first end to engage with a threaded cap 26. The cap 26 can be removably secured with the open first end of the container 24 in order to trap contents within the blender 20 during blending. The cap 26 has a first side that faces towards an interior of the container 24 when the cap 26 is engaged with the container 24 to enclose an interior of the container 24 and a second side that faces away from the interior of the container 24. In some embodiments, the cap 26 and/or the container 24 maybe provided with one or more seals to seal contents being blended within the interior of the container 24. In some embodiments, the container 24 and cap 26 maybe releasably engaged with one another through other means than the threaded connection of the exemplary embodiment. The container 24 and the cap 26 maybe made of plastic or any suitable material.

A rotating blade piece 28 is fixedly attached with and extends fully through and past opposite sides of the cap 26. In the exemplary embodiment, the rotating blade piece 28 is centrally located on the cap 26.

In the exemplary embodiment, the rotating blade piece 28 is made of metal (for example, stainless steel) and has a shaft or shank portion 30 that extends through a circular opening in the cap 26. The rotating blade piece 28 also includes a plurality of blades with sharp edges that are disposed on the first side of the cap 26 and that extend outwardly from the shank portion 30. In the example embodiment, the blades have a cross-blade configuration with four total blades being evenly spaced from one another around the shaft. In some embodiments, the blades could have other configurations, e.g., there could be more or fewer than four blades and the blades could have different features such as serrations depending on the types of objects to be blended.

Where it extends through the cap 26 from the first side of the cap 26 to the second side of the cap 26, the rotating blade piece 28 is sealed to the cap 26 to prevent the contents of the container 24 from leaking out of the container 24. In some embodiments, at least one elastomeric seal engages both a cylindrical portion of the shank 30 and the cap 26 to seal the rotating blade piece 28 against the cap 26. The rotating blade piece 28 may also be supported by one or more bearings to facilitate free rotation of the rotating blade piece 28 relative to the cap 26.

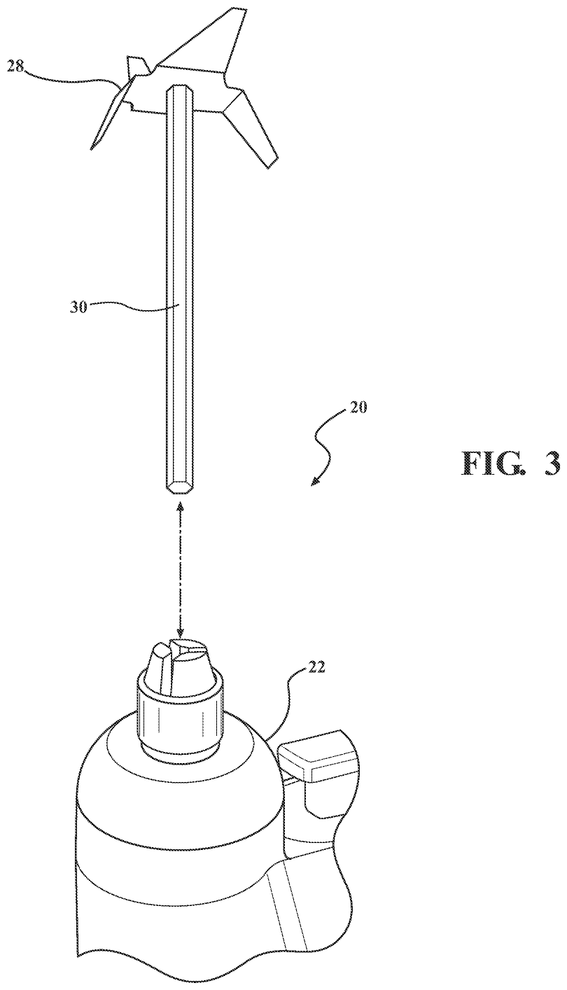

On an opposite side of the rotating blade 28 from the blades, the shank portion 30 is shaped to be received into the chuck of a handheld tool, such as a drill or an impact driver 22. As illustrated in FIG. 3, in the exemplary embodiment, the end of the shank portion 30 has a hexagonal shape so that it can be received in the chuck of an impact driver. In some embodiments, the shank portion can have other shapes, e.g., a circular shape. In some embodiments, the shank portion has an approximately one quarter inch (¼″) diameter. In other embodiments, the width or diameter of the shaft can be more or less than this.

The drill or impact driver 22 engages with the shank portion 30 on an opposite side of the cap 26. In some embodiments, the rotating blade 28 can be removable from the cap 26 and replaced when worn out or replaced with a differently configured rotating blade that is optimized for blending a different type of object.

In operation, the user fills the container 24 with an object to be blended, e.g., building materials to be mixed, or food (such as ice, fruits, soups, vegetables, etc.). The user then joins the cap 26 with the container 24. In the exemplary embodiment, the user threads the cap 26 onto the container 24 to trap the objects inside the interior of the container 24. Next, the user flips the container 24 upside down (so that the cap 26 is below the container 24) and inserts the shank portion 30 of the rotating blade 28 into to the chuck of the handheld tool 22 and tightens the chuck about the shank portion 30. The user can then turn on, or activate, the motorized handheld tool 22 to rotate the rotating blade piece 28 relative to the cap and blend the object in the container 24. If the handheld tool 22 has multiple speeds, then the user can adjust the blending rate by adjusting the speed on the handheld tool 22.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

What is claimed is:

1. A blender, comprising:
a container that has an open interior and at least one open end;
a cap that is attachable with the at least one open end of the container to enclose the open interior of the container; and
a rotatable blade piece that extends through the cap between a blade end on one side of the cap and a shank end on an opposite side of the cap, the blade end having a plurality of blades, and the shank end being shaped to be received in a chuck of a handheld tool.

2. The blender as set forth in claim 1, wherein at least a portion of the shank end of the rotatable blade piece has a hexagonal shape.

3. The blender as set forth in claim 1, wherein the blade end of the rotatable blade piece has at least four blades with sharp edges.

4. The blender as set forth in claim 1, wherein the cap is threadedly attachable with the at least one open end of the container.

5. The blender as set forth in claim 1, wherein the rotatable blade piece is made of metal.

6. A blender assembly, comprising:
a motorized handheld tool that includes a chuck;
a container that has an open interior and at least one open end;
a cap that is attachable with the at least one open end of the container to enclose the open interior of the container;
a rotatable blade piece that extends through the cap between a blade end on one side of the cap and a shank end on an opposite side of the cap, the blade end having a plurality of blades; and
the shank end of the rotatable blade piece being received in the chuck of the motorized handheld tool.

7. The blender assembly as set forth in claim 6, wherein at least a portion of the shank end of the rotatable blade piece has a hexagonal shape.

8. The blender assembly as set forth in claim 6, wherein the blade end of the rotatable blade piece has at least four blades with sharp edges.

9. The blender assembly as set forth in claim 6, wherein the cap is threadedly attachable with the at least one open end of the container.

10. The blender assembly as set forth in claim 6, wherein the rotatable blade piece is made of metal.

11. The blender assembly as set forth in claim 10, wherein the motorized handheld tool is an impact driver.

12. A method of blending a product, comprising the steps of:
inserting a product to be blended into a container that has an open interior and at least one open end;
fixing a cap to the at least one open end of the container to enclose the product within the open interior, a rotatable blade piece extending through the cap, the rotatable blade piece having a blade end that is disposed within the open interior of the container and a shank end that is disposed outside of the open interior of the container;
inverting the container so that the container is vertically above the cap;
inserting a shank end of the rotatable blade piece into a chuck of a motorized handheld tool; and
activating the motorized handheld tool to rotate the rotatable blade piece relative to the cap and blend the product in the open interior of the container.

13. The method as set forth in claim 12, wherein at least a portion of the shank end of the rotatable blade piece has a hexagonal shape.

14. The method as set forth in claim 12, further including the step of threadedly engaging the cap with the at least one open end of the container.

15. The method as set forth in claim 12, wherein the rotatable blade piece is made of metal.

16. The method as set forth in claim 12, wherein the motorized handheld tool is an impact driver.
